(19) United States
(12) Patent Application Publication
(10) Pub. No.: US 2010/0254751 A1
(43) Pub. Date: Oct. 7, 2010

(54) TELESCOPING POLE SYSTEM

(75) Inventor: Joseph F. McMillan, III, Portland, OR (US)

Correspondence Address: Joseph F. McMillan, 4428 NE Skidmore St., Portland, OR, 97218, US

(73) Assignee: Joseph F. McMillan, III, Portland, OR (US)

(21) Appl. No.: 12/753,062

(22) Filed: Apr. 1, 2010

Related U.S. Application Data
(60) Provisional application No. 61/166,027, filed on Apr. 2, 2009.

(51) Int. Cl. F16B 7/10

(52) U.S. Cl. 403/109.1; 403/109.3

(57) ABSTRACT

Embodiments relating to a telescoping pole system are provided. Such a telescoping pole system may be adjusted by user manipulation to vary a length of the telescoping pole system.

### PRIORITY CLAIM

The present application claims priority to provisional patent application U.S. 61/166,027, titled ADJUSTMENT MECHANISM FOR TELESCOPING POLES, filed Apr. 2, 2009 by inventor Joseph F. McMillan III, the entire contents of which are incorporated herein by reference in their entirety for all purposes.

### BACKGROUND

Adjustable poles may be implemented in a variety of ways. As one example, in the context of sports equipment, hiking poles and ski poles may comprise one or more adjustable pole elements for increasing or reducing pole length. As another example, walking canes and walkers may comprise one, two, three, four, or more legs, each having one or more adjustable pole elements for adjusting pole length. Adjustable poles may be utilized in still other contexts outside of personal tools or implements. For example, vehicle roof racks may comprise telescoping poles for varying a carrying capacity. Such adjustable poles typically include one or more pole elements nested within at least one other pole element which may be translated relative to each other to increase or reduce pole length.

### SUMMARY

Embodiments relating to a telescoping pole system are disclosed. In one example embodiment, the telescoping pole system comprises at least a first pole piece; a second pole piece having a first retaining element; and a deforming member. The first retaining element is one of a plurality of retaining elements of the second pole piece. The deforming member has a second retaining element disposed between a first end and a second end of the deforming member. The first end of the deforming member is fixed to the first pole piece and is deformable to enable movement of the second end relative to the first end responsive to an input force applied at the deforming member. The second retaining element is adapted to be unmated from the first retaining element responsive to the input force applied at the deforming member to enable the first pole piece and the second pole piece to move relative to each other. Such movement of the first pole piece and the second pole piece relative to each other may be inhibited by removal of the input force from the second end of the deforming member to enable the second retaining element to be mated with a select one of the plurality of retaining elements.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 shows an example telescoping pole system according to one embodiment.

FIGS. 3-5 show the example telescoping pole system of FIG. 1 as it may be adjusted to obtain different lengths.

FIG. 5 shows another view of the example telescoping pole system of FIG. 1.

FIG. 6 shows a cutaway view of the example telescoping pole system of FIG. 5.

FIG. 7 shows a detailed cutaway view of the example telescoping pole system of FIG. 1.

FIG. 8 shows a detailed cutaway view of an example telescoping pole system according to one embodiment.

FIG. 9 shows an example deforming element for a telescoping pole system according to one embodiment.

FIG. 10 shows an example deforming element for a telescoping pole system according to another embodiment.

FIG. 11 shows a detailed cutaway view of the telescoping pole system of FIG. 1 along a section depicted in FIG. 12.

FIGS. 12-14 show other views of the example telescoping pole system of FIG. 1 depicting an example handle end of the telescoping pole system.

### DETAILED DESCRIPTION

A telescoping pole system is disclosed that may be operated by a user to adjust a length of the telescoping pole system. While many of the disclosed embodiments are described in the context of a telescoping pole system for a hiking pole, it will be appreciated that such disclosed elements and features may be applicable to telescoping pole systems implemented in other contexts including, for example, ski poles, Nordic walking poles, wading staffs, fishing poles, measuring sticks, camera supports, tripod legs, chair legs, stool legs, table legs, reaching poles, ladder legs or supports, canes, crutches, walker legs, vehicle roof racks, strollers, luggage, etc. Hence, while a disclosed embodiment of the telescoping pole system includes an ambulatory aid implementation, it will be appreciated that other implementations of the disclosed telescoping pole system may be utilized, particularly where rapid and/or convenient adjustment of pole length or height is desired.

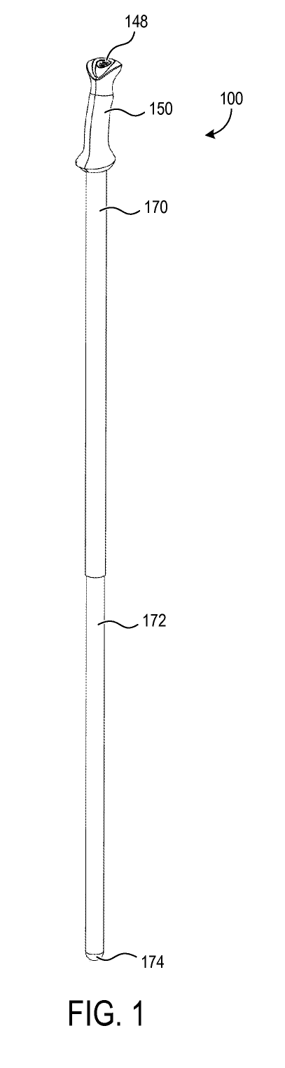

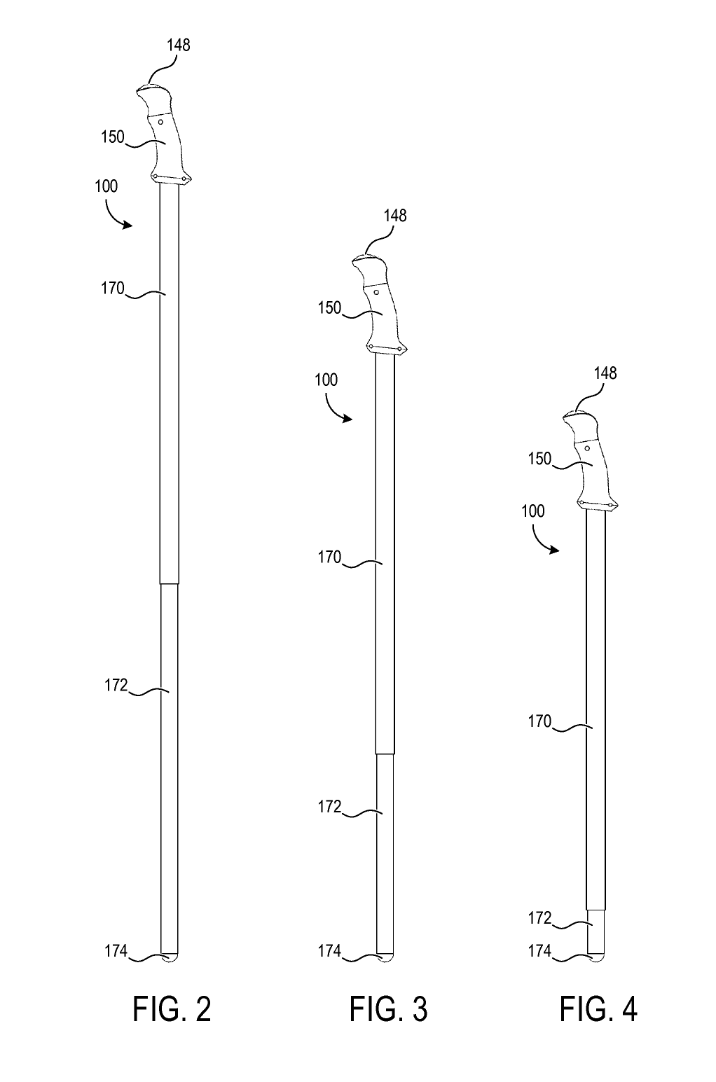

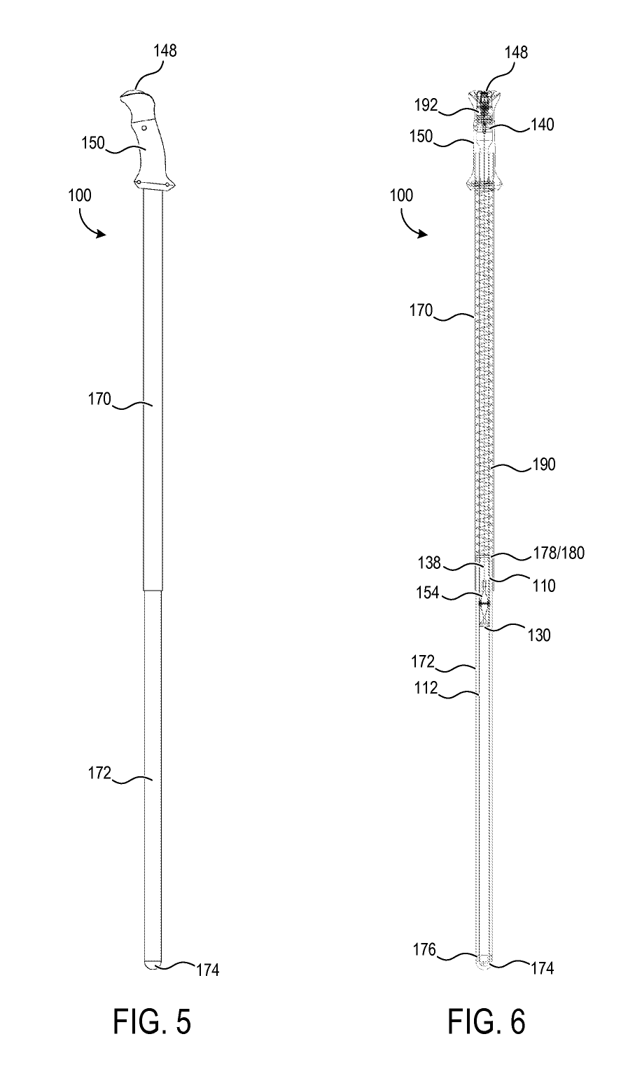

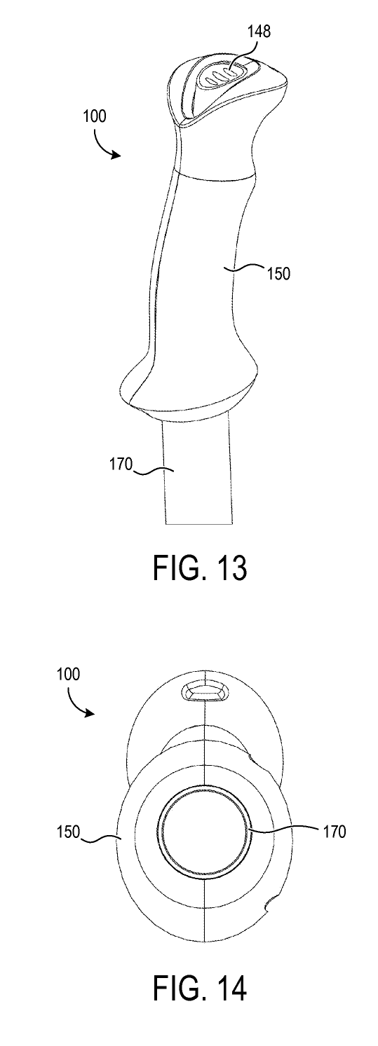

Referring to FIGS. 1-14, a telescoping pole system 100 is shown. Telescoping pole system 100 may include at least a first pole piece 110 and a second pole piece 112. In some embodiments, first pole piece 110 and/or second pole piece 112 may each comprise a tube defining a hollow interior region. First pole piece 110 may be retained at least partially within the hollow interior region of second pole piece 112 in such embodiments as shown, for example, in FIG. 8. Second pole piece 112 may have an inner diameter or width that is sufficiently larger than an outer diameter of first pole piece 110, so as to allow freedom of movement in the same axis as the longest dimension (e.g., along the longitudinal axis) of the telescoping pole system, but also reducing or minimizing relative motion in lateral directions that are orthogonal to this longest dimension. First pole piece 110 and second pole piece 112 may have any suitable cross-sectional shape, including circular, ovular, square, rectangular, among others. As one example, first pole piece 110 and second pole piece 112 may have a square or rectangular cross-section to provide one or more flat surfaces with which first pole piece 110 and second pole piece 112 may move (e.g., translate or slide) relative to each other. Such square, rectangular, or other rectilinear cross-sections may enable internal components of telescoping pole system 100 access to one or more flat surfaces of first pole piece 110 and/or second pole piece 112 for locking and/or unlocking such pole pieces relative to each other.

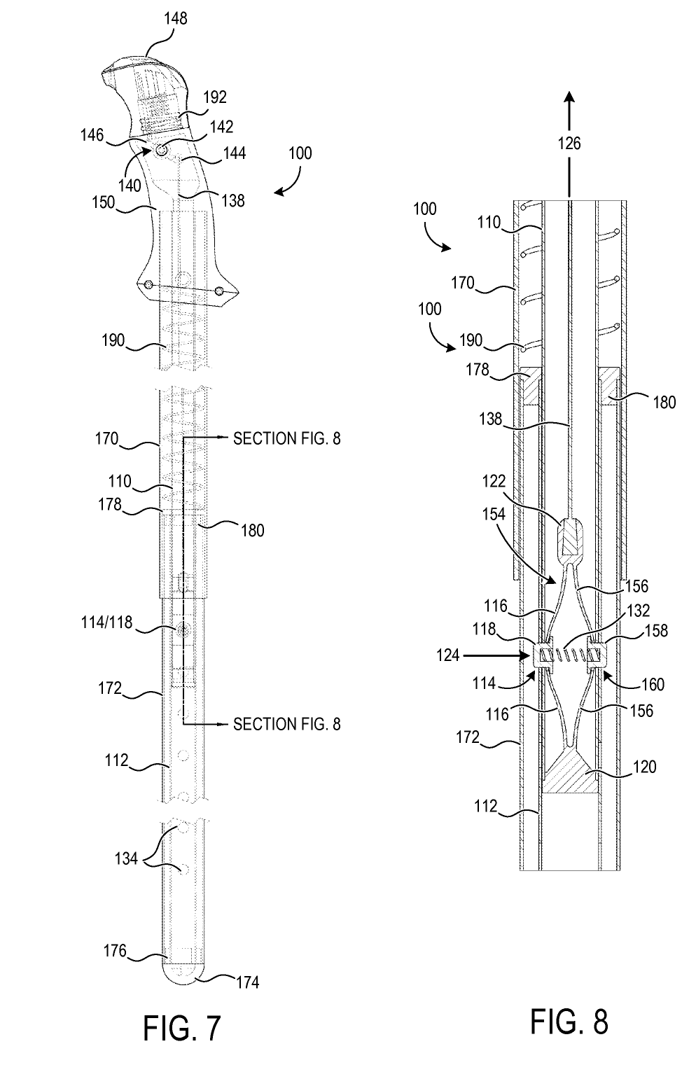

For example, second pole piece 112 may have at least a first retaining element 114 shown, for example, in FIG. 7. Telescoping pole system 100 may further include a deforming member 116 (examples of which are shown in greater detail in FIGS. 8, 9, and 10) having a second retaining element 118 disposed between a first end 120 and a second end 122 of deforming member 116. Deforming member 116 may be deformable to enable movement of second end 122 relative to first end 120 responsive to an input force applied at second end 122 of deforming member 116. Second retaining element 118 may be adapted to be unmated from first retaining element 114 responsive to the input force applied at second end 122 of deforming member 116. In some embodiments, second retaining element 118 is adapted to be unmated from first retaining element 114 (e.g., as indicated by vector 124) responsive to the input force applied at second end 122 of deforming member 116 being applied along a vector 126 that points away from first end 120 of deforming member 116 to cause second end 122 of deforming member 116 to move away from first end 120 of deforming member 116. In other embodiments, second retaining element 118 is adapted to be instead mated with first retaining element 114 as (e.g., as indicated by a vector that points in an opposite direction as vector 124) responsive to an input force applied at second end 122 of deforming member 116 to cause second end 122 of deforming member to move toward first end 120 of deforming member 116.

In some embodiments, second retaining element 118 comprises a protrusion (e.g., a locking button having a round cross-section or other suitable shaped cross-section) that protrudes from a front face 128 of deforming member 116 between first end 120 and second end 122 of the deforming member as shown in greater detail in FIG. 10, for example. As shown in FIG. 8, front face 128 of deforming member 116 may face an inner wall of second pole piece 112. Furthermore, as shown in FIG. 8, deforming member 116 may be disposed within first pole piece 110 such that front face 128 of deforming member 116 may also face an inner wall of first pole piece 110.

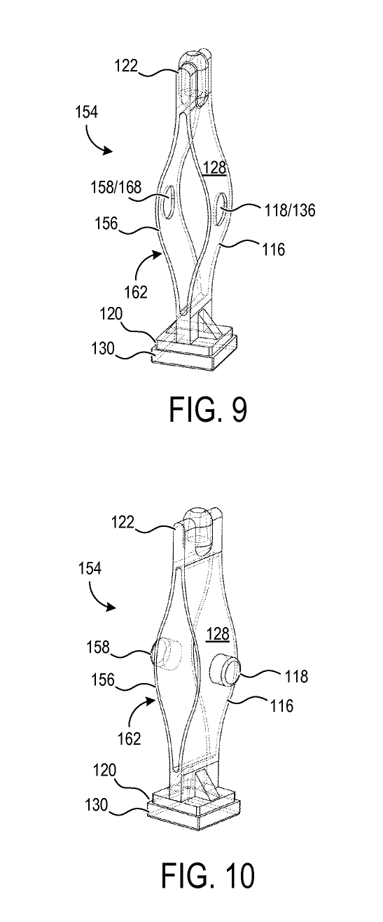

Accordingly, first retaining element 114 may comprise an opening or a recess defined in a body (e.g., at the inner wall) of second pole piece 112 for receiving a protrusion of second retaining element 118 as shown in FIG. 7, for example. In other embodiments, a first retaining element of second pole piece 112 may instead comprise a protrusion that protrudes from a surface (e.g., an inner surface) of the second pole piece, and a second retaining element of deforming member 116 may instead comprise an opening or a recess defined in a body of the deforming member between first end 120 and second end 122 of the deforming member for receiving the protrusion of the first retaining element, for example, as shown in FIG. 9.

In some embodiments, first end 120 of deforming member 116 may be fixed to first pole piece 110. For example, as shown in FIGS. 8, 9, and 10, first end 120 may comprise an end cap 130 of first pole piece 110 for embodiments where first pole piece 110 comprises a tube defining a hollow interior region. However, it will be appreciated first end 120 may be fixed to first pole piece 110 using other suitable approaches. In some embodiments, deforming member 116 may comprise a leaf spring or a flat spring that is adapted to urge second retaining element 118 toward first retaining element 114. In some embodiments, telescoping pole system 100 may further comprise a spring 132 having a first end disposed at a rear face of deforming member 118 opposite front face 128 of the deforming member that faces first retaining element 114. For example, spring 132 may apply a spring force at the rear face of deforming member 116 that urges second retaining element 118 disposed at front face 128 of the deforming member toward first retaining element 114 of second pole piece 112. As another example, spring 132 may instead apply a spring force at deforming member 116 that urges second retaining element 118 away from first retaining element 114 of second pole piece 112.

In some embodiments, first retaining 114 element may be one of a plurality of retaining elements 134 of second pole piece 112. The plurality of retaining elements 134 may be spaced apart from each other along a longitudinal axis of second pole piece 112 as shown in FIG. 7, for example. For example, as shown in FIG. 7, each retaining element (including first retaining element 114) of the plurality of retaining elements 134 may comprise an opening or a recess defined in a body of second pole piece 112 for receiving a protrusion of second retaining element 118 of deforming member 116. As another example, each retaining element of the plurality of retaining elements 134 may instead comprise a protrusion that is adapted to be mated with or unmated from an opening or a recess 136 in deforming member 116, for example, as shown in FIG. 9. Accordingly, second retaining element 118 may be adapted to be mated with or unmated from a select one of the plurality of retaining elements 134 including first retaining element 114 responsive to an input force applied at second end 122 of deforming member 116. For example, second retaining element 118 may be unmated from first retaining element 114 responsive to an input force applied at deforming member 116 to enable first pole piece 110 and second pole piece 112 to move or be moved relative to each other. Such movement of first pole piece 110 and second pole piece 112 relative to each other may be inhibited by removal of the input force from deforming member 116 to enable second retaining element 118 to be mated with a select one of the plurality of retaining elements 134, thereby locking first pole piece 110 relative to second pole piece 112 at a select length.

In some embodiments, telescoping pole system 100 may further include a transmitting member 138 having a first end coupled to deforming member 116 for transmitting an input force to deforming member 116. As one example, transmitting member 138 may transmit an input force to second end 122 of deforming member 116. Transmitting member 138 when embodied as a tensile force transmitting member may be made of or comprise any suitable material that is sufficiently light weight, strong, and non-stretchable as to provide transfer of motion and an input force between e.g., lever 140 and deforming element 154. For example, in some embodiments, transmitting member 138 may comprise a cable or a cord for transmitting an input force to deforming member 116 along a vector 126. However, transmitting member may comprise any suitable structure (e.g., a rigid linkage) for transmitting an input force to deforming member 116, including elements that can support compressive forces in addition to tensile forces.

In some embodiments, telescoping pole system 100 may further include a lever 140 having a pivot post 142 fixed to first pole piece 110, a first lever arm 144 coupled to a second end of transmitting member 138, and a second lever arm 146 coupled to a control element 148. In some embodiments, telescoping pole system 100 may further include a handle 150 coupled to first pole piece 110. In some embodiments, pivot post 142 of lever 140 may be fixed to first pole piece 110 via handle 150, for example, as shown in FIG. 7. Control element 148 may comprise a depressible button that is accessible at handle 150 of telescoping pole system 100 in some embodiments. For example, handle 150 may comprise a handle body that defines an opening or a recess through which control element 148 is accessible by a user to enable the user to apply an input force to deforming member 116 (e.g., by depressing control element 148). However, it will be appreciated that control element 148 may comprise a trigger or other suitable element for enabling a user to apply an input force at deforming member 116. In some embodiments, an input force may be transmitted from control element 148 to second lever arm 146 via element 152. Accordingly, control element 148 may be disposed at a first end of first pole piece 110 opposite a second end to which deforming member 116 is fixed in such embodiments. It will be appreciated that control element 148 may be operatively coupled to deforming member 116 using any suitable system, element, or collection of elements for transmitting an input force applied by a user at control element 148 to deforming member 116.

In some embodiments, deforming member 116 is a first deforming member 116 of a deforming element 154 that further comprises a second deforming member 156. First deforming member 116 and second deforming member 156 may be spaced apart from each other and joined at first end 120 and at second end 122 of deforming element 154. Accordingly, second deforming member 156 may have a first end that is coupled to a first end of first deforming member 116 and a second end that is coupled to a second end of first deforming member 116. Second deforming member 156 may have a third retaining element 158 disposed between first end 120 of second deforming member 156 and second end 122 of second deforming member 156. Hence, first end 120 of second deforming member 156 may be fixed to first pole piece 110. Second deforming member 156 may also be deformable (e.g., similar to first deforming member 116) to enable movement of second end 122 of the second deforming member relative to first end 120 of the second deforming member responsive to an input force applied at the second end of the first deforming member and the second deforming member (e.g., along vector 126). Third retaining element 158 may be adapted to be mated with or unmated from a fourth retaining element 160 of second pole piece 112 responsive to the input force applied at second end 122 of first deforming member 116 and second deforming member 156.

In some embodiments, deforming element 154, retaining element 118, and third retaining element 158 may be integrated into a common part as shown, for example, in FIG. 10. In such embodiments, deforming element 154 may be formed from a common material such as plastic or metal, for example. In other embodiments, deforming element 154 may comprise openings in deforming members 116 and 156 for receiving independent retaining elements 118 and 158 as shown in FIG. 9. In such embodiments, retaining elements 118 and 154 may be held in place relative to deforming element 154 by spring 132.

In some embodiments, second retaining element 118 of first deforming member 116 and third retaining element 158 of second deforming member 156 may be diametrically opposed to each other as shown, for example, in FIG. 9. In some embodiments, third retaining element 158 comprises a protrusion similar to second retaining element 118 that protrudes from a front face 162 of second deforming member 156 between first end 120 and second end 122 of the second deforming member. Front face 162 of second deforming member 156 may face a second inner wall of second pole piece 112 substantially opposite a first inner wall of the second pole piece which faces second retaining element 118. Fourth retaining element 160 may comprise an opening or a recess defined in a body of the second pole piece similar to first retaining element 114 for receiving the protrusion of third retaining element 158. In other embodiments, fourth retaining element 160 of second pole piece 112 may instead comprise a protrusion similar to first retaining element 114 that protrudes from an inner surface of the second pole piece, and third retaining element 158 may instead comprise an opening or a recess defined in a body of second deforming member 156 between first end 120 and second end 120 of the second deforming member similar to second retaining element 118/136 for receiving the protrusion of fourth retaining element 160.

In some embodiments, fourth retaining element 160 may be one of a second plurality of retaining elements of second pole piece 112. The second plurality of retaining elements (similar to plurality of retaining element 134) may be spaced apart from each other along the longitudinal axis of second pole piece 112. In such embodiments, each retaining element (including fourth retaining element 160) of the second plurality of retaining elements may comprise an opening or a recess defined in a body of second pole piece 112 for receiving a protrusion of third retaining element 158 of deforming member 156. As another example, each retaining element of the second plurality of retaining elements may instead comprise a protrusion that is adapted to be mated with or unmated from an opening or a recess 168 in second deforming member 156, for example, as shown in FIG. 9. Accordingly, third retaining element 158 may be adapted to be mated with or unmated from a select one of the second plurality of retaining elements including fourth regaining element 160 responsive to an input force applied at second end 122 of second deforming member 156.

For example, third retaining element 158 may be unmated from fourth retaining element 160 and second retaining element 118 may be unmated from first retaining element 114 responsive to an input force applied at both first deforming member 116 and second deforming member 156 (e.g., at end 122) to enable first pole piece 110 and second pole piece 112 to move or be moved relative to each other. Such movement of first pole piece 110 and second pole piece 112 relative to each other may be inhibited by removal of the input force from one or both of first deforming member 116 and second deforming member 156 to enable second retaining element 118 to be mated with a select one of the plurality of retaining elements 134 and/or to enable third retaining element 158 to be mated with a select one of the second plurality of retaining elements including, for example, fourth retaining element 160.

In some embodiments, telescoping pole system 100 may further include a first pole fascia 170 that substantially surrounds at least a portion of first pole piece 110 and/or a second pole fascia 172 that substantially surrounds at least a portion of second pole piece 112. In some embodiments, first pole fascia 170 and/or second pole fascia 172 may each comprise a tube that defines a hollow interior region. Second pole fascia 172 may be retained at least partially within the hollow interior region of first pole fascia 170 in such embodiments. An outer diameter or width of second pole fascia 172 may be sufficiently smaller than an inner diameter or width of first pole fascia 170 so as to allow freedom of movement in the same axis as the longest dimension (e.g., a longitudinal axis) of the pole system, but also reducing or inhibiting relative motion in a lateral direction that is orthogonal to the longest dimension. A lower tube assembly of telescoping pole system 100 comprising second pole piece 112, second pole fascia 172, end cap 174, and spacer 178 may move as one unit inside of a space defined by first pole piece 110 and first pole fascia 170.

First pole fascia 170 and second pole fascia 172 may have any suitable cross-sectional shape, including circular, ovular, square, and rectangular, among others. First pole fascia and/or second pole fascia may be load bearing in some embodiments to support compressive and/or tensile forces in addition to forces supported by first pole piece 110 and second pole piece 112. Furthermore, first pole fascia 170 and/or second pole fascia 172 may also provide protection to first pole piece 110 and second pole piece 112, and to exclude debris or other contaminants from first pole piece 110, second pole piece 112, internal working components such as deforming element 154 that may otherwise enter via openings formed in second pole piece 112 including, for example, retaining elements 114, 160, plurality of retaining elements 136, and the second plurality of retaining elements, etc. Furthermore, first pole fascia 170 and second pole fascia 172 may provide a different profile (e.g., cross-section) than provided by first pole piece 110 and second pole piece 112. For example, first pole fascia 170 and second pole fascia 172 may have round or ovular cross-sections, and first pole piece 110 and second pole piece 112 may have square or rectangular cross-sections. In some embodiments, first pole fascia 170 and/or second pole fascia 172 may be omitted from telescoping pole system 100.

In some embodiments, telescoping pole system 100 may further include an end cap 174. End cap 174 may include an outward or downward protrusion (e.g., a spike or pick) or a traction surface (e.g., plastic or rubber surface) in some embodiments. For example, if pole system 100 is embodied such that it may make contact with the ground or other surface at a distal end, then end cap 174 may also provide a surface that provides a suitable amount of friction with the ground or surface with which it contacts. End cap 174 may include one or more spacer elements 176 for fixing and/or retaining second pole piece 112 relative to second pole fascia 172. In some embodiments, telescoping pole system 110 may further include a spacer 178 including spacer elements 180 for fixing and/or retaining first pole piece 110 relative to first pole fascia 170. Handle 150 may further serve as a spacer comprising spacer elements for fixing and/or retaining first pole piece 110 relative to first pole fascia 170. In some embodiments, end cap 130 of deforming element 154 may provide a surface, bushing, and/or spacer element upon which second pole piece 112 may move (e.g., translate or slide) relative to first pole piece 110. Instead of an assembly of tubes and caps, a lower tube assembly comprising second pole piece 112 and second pole fascia 172 may be embodied as an integrated common assembly that is formed from a common material.

In some embodiments, telescoping pole system 100 may include a spring 190 disposed between second pole piece 112/second pole fascia 172 and first pole piece 110/first pole fascia 170 for urging pole piece 112/second pole fascia 172 and first pole piece 110/first pole fascia 170 relative to each other in a lengthening direction of telescoping pole system 100. However, spring 190 may urge pole piece 112/second pole fascia 172 and first pole piece 110/first pole fascia 170 relative to each other in an opposite direction to shorten a length of telescoping pole system 100 in other embodiments. An outer diameter of spring 190 may be less than or equal to an inner diameter of first pole fascia 170, and an inner diameter of spring 190 may be less than or equal to an outer diameter or width of first pole piece 110. A spring rate or spring force of spring 190 may be selected so that it does not prevent a typical user from compressing spring 190 with undue difficulty, for example, to thereby enable a reduction in a length of pole system 100 to be performed by the user against the spring force provided by spring 190. The spring rate or spring force of spring 190 may be selected so that it is sufficient to support at least the weight of an upper tube assembly comprising first pole piece 110 and first pole fascia 170, as well as supporting control element 148 and its receptor assembly (e.g., handle 150) when first pole piece 110 is unlocked relative to second pole piece 112 by deforming element 154 via actuation of control element 148. In some embodiments, telescoping pole system 100 may further include a spring 192 disposed between control element 148 and handle 150 and/or first pole piece 110 for urging control element 148 away from a position that causes unmating of second retaining member 118 and/or the third retaining member 158 from, for example, respective retaining members 114 and 160.

To operate telescoping pole system 100, a user may depress (or otherwise activate) and hold control element 148, and the user may either allow spring 190 to extend second pole piece 112/second pole fascia 172 relative to first pole piece 110/first pole fascia 170 or the user may push against and overcome a resistance of spring 190 (e.g., by applying a force downward at handle 150 while end cap 174 is resting on a ground surface) to shorten a length of telescoping pole system 100. A user may then release control element 148 (or otherwise stop activating control element 148) when pole system 100 has achieved a desired length corresponding to an alignment of at least second retaining element 118 and a select one of a plurality of retaining elements 134. When an input force is applied to control element 148, transmitting member 138 pulls deforming element 154 in tension in at least some embodiments, thereby flatting deforming element 154 in order to unmate (e.g., retract) second retaining element 118 and/or third retaining element 154 from respective retaining elements (e.g., 114 and 160) of second pole piece 112.

For example, responsive to a user depressing (or otherwise activating) control element 148, retaining elements 118 and/or 158 may be retracted at least from retaining elements 114 and/or 160 of second pole piece 112 and may be retracted within a wall of first pole piece 110 to enable second pole piece 112 to be moved (e.g., translated or slid) relative to first pole piece 110. Once control element 148 has been released by a user to remove an input force, spring 190 may urge second pole piece 112 to move (e.g., translate or slide) relative to first pole piece 110 until retaining element 118 finds a next one of the plurality of retaining elements 136 of second pole piece 112 and/or retaining element 158 finds a next one of the second plurality of retaining elements. Deforming members 116 and/or 156 may act in conjunction with spring 132 to return (e.g., extend outward) retaining elements 118 and/or 158 to a length that enables retaining elements 118 and/or 158 to be respectively mated with and hence pass into one of the plurality of retaining elements 136 and/or one of the second plurality of retaining elements, thus locking telescoping pole system 100 at a selected length.

In some embodiments, telescoping pole system 100 may further include three or more pole pieces to enable a length of the telescoping pole system to be adjusted at two or more locations. In such implementations, two or more transmitting members may be coupled to the same or different control elements and may be adapted to transmit the same or different input forces to independent deformable members located at different locations along the telescoping pole system to provide adjustment of the three or more pole pieces relative to each other.

Accordingly, deforming element 154 may comprise first deforming member 116 and second retaining element 118 while omitting second deforming member 156 and third retaining element 158 in some embodiments. While in other embodiments, deforming element 154 may comprise both first deforming member 116 and second deforming member 156 and respective second retaining element 118 and third retaining element 1158 for providing two points at which first pole piece 110 may be restrained from moving (e.g., translating or sliding) relative to second pole piece 112.

For embodiments where deforming element 154 is a separate or independent part from retaining elements 118 and 158 (e.g., as shown in FIG. 9), openings 136 and 168 in deforming members 128 and 156 may be elongated (e.g., ovular or non-circular) along a longitudinal axis of the first and second pole pieces to provide a distance between centers of the top and bottom radii of each respective hole. This distance between centers of the top and bottom radii of each of openings 136 and 168 may be great enough to provide sufficient tolerance to allow retaining elements 118 and 158 to be retracted and/or extended during respective unmating and mating operations. For example, the distance between centers of the top and bottom radii of each of openings 136 and 168 relative to respective retaining elements may be great enough to provide sufficient travel without binding of components. The top and bottom diameter (or radii) of such openings may be the same in some embodiments.

Retaining elements 118 and/or 158 and spring 132 may be embodied as one part with deforming element 154 itself. Deforming element 154 may also be embodied as flat spring with only one of retaining elements 118 and/or 158, or a flat spring with one or more protrusions taking the place of the separate buttons or protrusions of retaining elements 118 and/or 158. Flanges may be provided on retaining elements 118 and/or 158 in some embodiments, such as where such retaining elements comprise buttons that are separate from deforming element 154 to inhibit such retaining elements from passing all the way through their respective openings 136 and 168. Whether embodied as separate or unified with deforming member 154, retaining elements 118 and 158 may be selected to be long enough so that they can each protrude from each respective outer surfaces of first pole piece 110 so that they may project into respective openings or recesses in second pole piece 112.

The first plurality of retaining elements 136 for mating with second retaining element 118 and the second plurality of retaining elements for mating with third retaining element 158 may be spaced apart from each other at uniform intervals and may be spaced close enough to each other to provide a sufficient number of selectable pole lengths without sacrificing the structural integrity of second pole piece 112. The first plurality of retaining elements 136 for mating with second retaining element 118 and the second plurality of retaining elements for mating with third retaining element 158 may be provided in-line and on opposing sides of second pole piece 112.

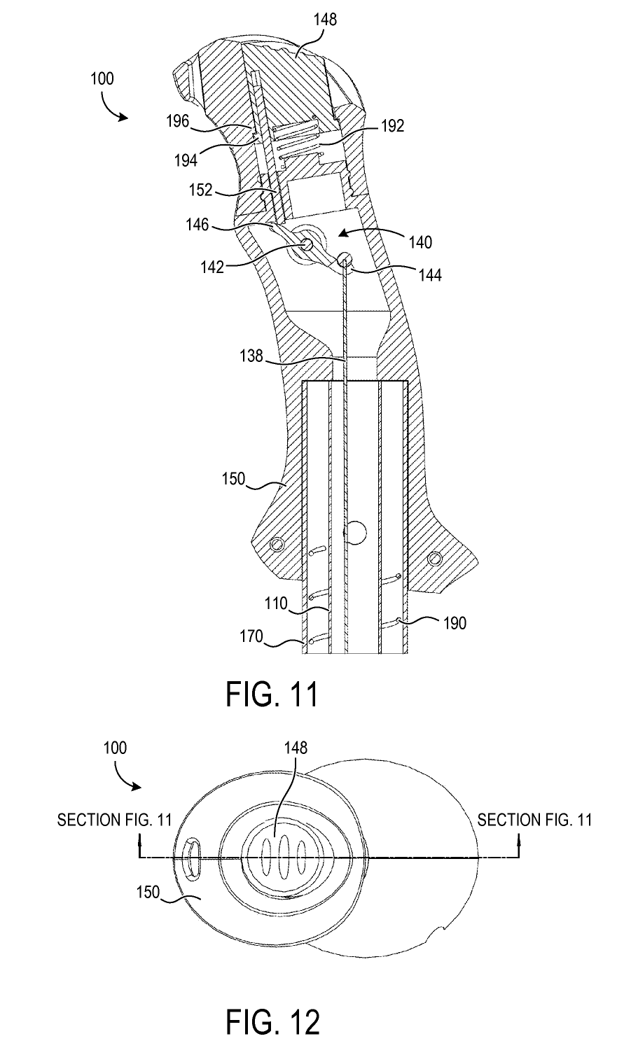

As described above, receptor for retaining control element 148 may be shaped as a handle such as handle 150 that is ergonomically shaped to fit a hand as shown, for example, in FIGS. 11-14. However, such a receptor may have other suitable shapes depending on the implementation of the telescoping pole system. For example, a receptor for control element 148 may be shaped to match a profile of first pole fascia 170. Regardless of a shape of the receptor for control element 148, spring 192 may be located between a bottom surface of control element 148 and an internal upper surface of the adjustment button receptor in at least some embodiments. Respective flanges 194 and 196 of control element 148 and the receptor (e.g., handle 150) for receiving control element 148 may interfere with one another to retain control element 148 within the receptor.

One advantage of the telescoping pole system disclosed herein is that a user may adjust a length or height of the telescoping pole system by manipulating a control element that is conveniently located, for example, at a handle end of the telescoping pole system. Another advantage of the telescoping pole system is that a time and/or energy in which it takes a user to adjust a length or height of the telescoping pole system may be reduced relative to other adjustable poles, for example, as a result of the conveniently located control element. It will be appreciated that such advantages are non-limiting, and that other advantages may be provided by the disclosed embodiments.

Further aspects of the present disclosure will become apparent from the drawings and written description, which may enable a person skilled in the art to modify disclosed embodiments and implementations without departing from the spirit and scope of the disclosed subject matter. Accordingly, the subject matter of the present disclosure includes all novel and nonobvious combinations and subcombinations of the various embodiments and implementations disclosed herein. Thus, the drawings and written description of the present disclosure are to be regarded as illustrative in nature and not restrictive.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure. It will be appreciated that at least some of the disclosed elements of the telescoping pole system may be omitted from at least some embodiments where claimed subject matter does not specifically recite such elements.

1. A telescoping pole system, comprising:
a first pole piece;
a second pole piece having a first retaining element; and
a deforming member having a second retaining element disposed between a first end and a second end of the deforming member,
the first end of the deforming member fixed to the first pole piece,
the deforming member deformable to enable movement of the second end relative to the first end responsive to an input force applied at the second end of the deforming member,
the second retaining element adapted to be unmated from the first retaining element responsive to the input force applied at the second end of the deforming member.

2. The telescoping pole system of claim 1, wherein the second retaining element comprises a protrusion that protrudes from a front face of the deforming member between the first end and the second end of the deforming member; and
wherein the first retaining element comprises an opening or a recess defined in a body of the second pole piece for receiving the protrusion of the second retaining element.

3. The telescoping pole system of claim 2, wherein the first retaining element is one of a plurality of retaining elements of the second pole piece;
wherein each retaining element of the plurality of retaining elements comprises an opening or a recess defined in the body of the second pole piece for receiving the protrusion of the second retaining element, and
wherein the plurality of retaining elements are spaced apart from each other along a longitudinal axis of the second pole piece.

4. The telescoping pole system of claim 1, wherein the first retaining element comprises a protrusion that protrudes from a surface of the second pole piece; and
wherein the second retaining element comprises an opening or a recess defined in a body of the deforming member between the first end and the second end of the deforming member for receiving the protrusion of the first retaining element.

5. The telescoping pole system of claim 1, wherein the second retaining element is adapted to be unmated from the first retaining element responsive to the input force applied at the second end of the deforming member being applied along a vector that points away from the first end of the deforming member to cause the second end of deforming member to move away from the first end of the deforming member.

6. The telescoping pole system of claim 1, wherein the deforming member comprises a leaf spring or a flat spring that is adapted to urge the second retaining element toward the first retaining element.

7. The telescoping pole system of claim 1, further comprising a spring having a first end disposed at a rear face of the deforming member opposite a front face of the deforming member that faces the first retaining element;
wherein the spring applies a spring force at the rear face of the deforming member that urges the second retaining element disposed at the front face of the deforming member toward the first retaining element.

8. The telescoping pole system of claim 1, further comprising a transmitting member having a first end coupled to the second end of the deforming member for transmitting the input force to the second end of the deforming member.

9. The telescoping pole system of claim 8, further comprising a lever having a pivot post fixed to the first pole piece, a first lever arm coupled to a second end of the transmitting member, and a second lever arm coupled to a control element.

10. The telescoping pole system of claim 9, further comprising a handle coupled to the first pole piece; and
wherein the control element comprises a button that is accessible at the handle.

11. The telescoping pole system of claim 8, wherein the transmitting member comprises a cable or a cord.

12. The telescoping pole system of claim 1, wherein the deforming member is a first deforming member and wherein the telescoping pole system further comprises a second deforming member having a first end that is coupled to the first end of the first deforming member and a second end that is coupled to the second end of the first deforming member,
the second deforming member having a third retaining element disposed between the first end of the second deforming member and the second end of the second deforming member,
the first end of the second deforming member fixed to the first pole piece,
the second deforming member deformable to enable movement of the second end of the second deforming member relative to the first end of the second deforming member responsive to the input force applied at the second end of the first deforming member and the second end of the second deforming member,
the third retaining element adapted to be unmated from a fourth retaining element of the second pole piece responsive to the input force applied at the second end of the first deforming member and the second end of the second deforming member.

13. The telescoping pole system of claim 12, wherein the second retaining element of the first deforming member and the third retaining element of the second deforming member are diametrically opposed to each other.

14. The telescoping pole system of claim 1, wherein the second pole piece comprises a tube defining a hollow interior region; and
wherein the first pole piece is retained at least partially within the hollow interior region of the second pole piece.

15. The telescoping pole system of claim 14, further comprising:
a first pole fascia that substantially surrounds at least a portion of the first pole piece; and
a second pole fascia that substantially surrounds at least a portion of the second pole piece;
wherein the first pole fascia comprises a tube defining a hollow interior region;
wherein the second pole fascia is retained at least partially within the hollow interior region of the first pole fascia.

16. A telescoping pole system, comprising:
a first pole piece;
a second pole piece having a plurality of openings or recesses defined in a body of the second pole piece, the plurality of openings or recesses spaced apart from each other along a longitudinal axis of the second pole piece;
a deforming member having a protrusion that protrudes from a front face of the deforming member between a first end and a second end of the deforming member; and
a control element disposed at a first end of the first pole piece and operatively coupled to the second end of the deforming member;
wherein the first end of the deforming member is fixed to a second end of the first pole piece, the deforming member deformable to enable movement of the second end of the deforming member relative to the first end of the deforming member responsive to an input force applied at the second end of the deforming member by the control element, and
wherein the protrusion is adapted to be unmated from a select one of the plurality of openings or recesses responsive to the input force applied at the second end of the deforming member by the control element.

17. The telescoping pole system of claim 16, wherein the second pole piece comprises a tube defining a hollow interior region, wherein at least the second end of the first pole piece is retained within the hollow interior region of the second pole piece; and
wherein the telescoping pole system further comprises a handle coupled to the first end of the first pole piece, wherein the handle has a handle body defining an opening or a recess through which the control element is accessible to apply the input force to the deforming member.

18. The telescoping pole system of claim 17, further comprising a transmitting member, wherein the control element is coupled to the deforming member via the transmitting member, wherein the transmitting member comprises a cable or a cord, and wherein the protrusion is adapted to be unmated from the select one of the plurality of openings or recesses responsive to the input force applied at the second end of the deforming member being applied along a vector that points away from the first end of the deforming member to cause the second end of deforming member to move away from the first end of the deforming member.

19. The telescoping pole system of claim 18, wherein the deforming member comprises a leaf spring or a flat spring that is adapted to urge the protrusion toward the select one of the plurality of openings or recesses; and
wherein the telescoping pole system further comprises a spring having a first end disposed at a rear face of the deforming member opposite the protrusion of the deforming member that faces the plurality of openings or recesses of the second pole piece;
wherein the spring applies a spring force at the rear face of the deforming member that urges the protrusion disposed at the front face of the deforming member toward the select one of the plurality of openings or recesses.

20. An apparatus, comprising:
a telescoping pole system, comprising:
a first pole piece;
a second pole piece comprising a tube having a first opening or recess defined in a body of the tube at a first inner wall of the tube and a second opening or recess defined in the body of the tube at a second inner wall of the tube substantially opposite the first inner wall;
a deforming element including a first deforming member and a second deforming member spaced apart from each other and joined at a first end and at a second end of the deforming element;
a control element disposed at a first end of the first pole piece and operatively coupled to the second end of the deforming element via a transmitting member;
wherein the first end of the deforming element is fixed to a second end of the first pole piece, the first deforming member and the second deforming member deformable to enable movement of the second end of the deforming element relative to the first end of the deforming element responsive to an input force applied at the second end of the deforming element by the control element via the transmitting member;
wherein the first deforming member includes a first protrusion that protrudes from a front face of the first deforming member between the first end and the second end of the deforming element, the front face of the first deforming member facing the first inner wall;
wherein the second deforming member includes a second protrusion that protrudes from a front face of the second deforming member between the first end and the second end of the deforming element, the front face of the second deforming member facing the second inner wall; and
wherein the first protrusion is adapted to be unmated from the first opening or recess and wherein the second protrusion is adapted to be unmated from the second opening or recess responsive to the input force applied at the second end of the deforming member by the control element via the transmitting member.
